(19) United States
(12) Patent Application Publication
(10) Pub. No.: US 2003/0141610 A1
(43) Pub. Date: Jul. 31, 2003

(54) Servo drive type automatic mold-adjusting control method

(76) Inventors: Hsing-Chang Liu, Hsinchu City (TW); Ken-Hsien Lai, Hsinchu Hsien (TW); Han-Chieh Chang, Taipei (TW); Yu-Chu Hsu, Chu Pei City (TW)

Correspondence Address: RABIN & CHAMPAGNE, PC, 1101 14TH STREET, NW, SUITE 500, WASHINGTON, DC, 20005, US

(21) Appl. No.: 10/054,926

(22) Filed: Jan. 25, 2002

(51) Int. Cl. B29C 45/80

(52) U.S. Cl. 264/40.1

(57) ABSTRACT

The present invention provides a servo drive type automatic mold-adjusting control method. When a toggle of a mold-clamping unit of a servo drive type injection molding machine stretches straight, if a mobile moldboard exactly contacts a static moldboard, the mold-clamping force will be near zero at this time. Assume the toggle recedes a distance and a mold-adjusting board and the mobile moldboard move forwards another distance and are then fixed, if the toggle stretches straight at this time, the mobile moldboard cannot move forwards continually because it already contacts the static moldboard. Therefore, advance of the motor will result in deformation of tie bars, hence building the mold-locking force.

### FIELD OF THE INVENTION

The present invention relates to a servo drive type automatic mold-adjusting control method and, more particularly, to a more accurate, faster, and more sensitive automatic mold-adjusting control method, which can be used to resolve problems of the conventional oil press type injection molding machine due to bad automatic mold-adjusting control, thereby enhancing precision and performance of machine to achieve the object of accurate shaping.

### BACKGROUND OF THE INVENTION

Referring to FIG. 1, a conventional oil press type injection molding machine comprises a static moldboard 10a, a mold-adjusting board 11a, a mobile moldboard 12a disposed between the static moldboard 10a and the mold-adjusting board 11a, and a mold-clamping unit 13a for driving the mobile moldboard 12a to move. A first mold 14a is fixed on the static moldboard 10a. The mobile moldboard 12a are slidably matched with tie bars 16a near four corners thereof. The mold-clamping unit 13a is a toggle mechanism capable of properly driving the mobile moldboard 12a to move through the guidance and support of the tie bars 16a so as to lead a second mold 15a on the mobile moldboard 12a to move, thereby letting the first mold 14a and the second mold 15a be capable of making open and close actions.

In a conventional oil press type injection molding machine, the power source of oil (fluid) is matched with oil press motors and valves to perform automatic mold-adjusting control. However, compression and viscosity of oil often leads bad transmission to affect the accuracy of automatic mold adjustment, resulting in unstable quality of shaping and thus affecting performance of machine.

Accordingly, the above oil press type injection molding machine has drawbacks and inconvenience in practical use. The present invention aims to resolve the problems in the prior art.

### SUMMARY OF THE INVENTION

The primary object of the present invention is to provide a servo drive type automatic mold-adjusting control method. The present invention makes use of turning on and off a servo motor and a mold-adjusting motor to perform automatic mold-adjusting control. Different from oil press, the present invention provides a more accurate, faster, and more sensitive automatic mold-adjusting control method, which can be used to resolve problems of a conventional oil press type injection molding machine due to bad automatic mold-adjusting control, thereby enhancing precision and performance of machine to achieve the object of accurate shaping.

To achieve the above object, the present invention provides a servo drive type automatic mold-adjusting control method comprising the steps of:

a user inputting the mold-locking force;

receding a first driving device to the rear end;

driving the second driving device to stretch straight a toggle to let the mobile moldboard exactly contact the static moldboard;

driving the second driving device to recede the toggle some distance;

driving the first driving device to move forwards and letting the mold-adjusting board and the mobile moldboard face forwards so that the mobile moldboard and the static moldboard are close together; and

stopping the first driving device to finish automatic mold adjustment.

The various objects and advantages of the present invention will be more readily understood from the following detailed description when read in conjunction with the appended drawing, in which:

### BRIEF DESCRIPTION OF THE DRAWINGS

FIG. 1 is a plan view of a conventional oil press type injection molding machine;

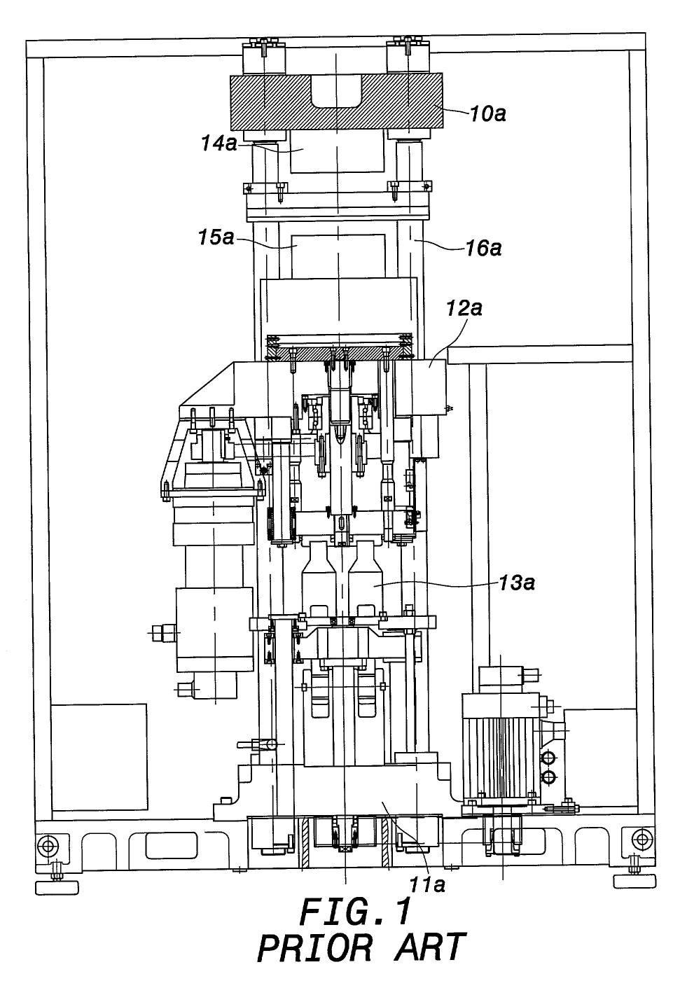

FIG. 2 is a flowchart of the automatic mold-adjusting control method of the present invention;

FIG. 3 is a plan view of a mold-clamping unit of the present invention;

FIG. 4 is an action diagram of the mold-clamping unit of the present invention; and

FIG. 5 is another action diagram of the mold-clamping unit of the present invention.

### DETAILED DESCRIPTION OF THE INVENTION

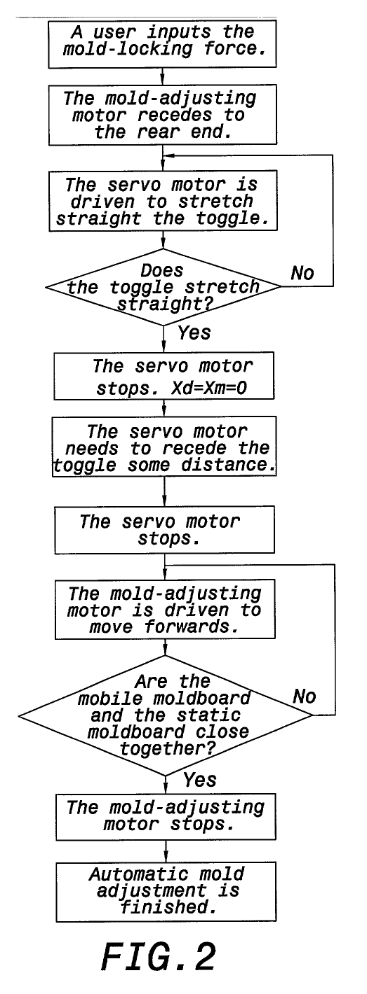

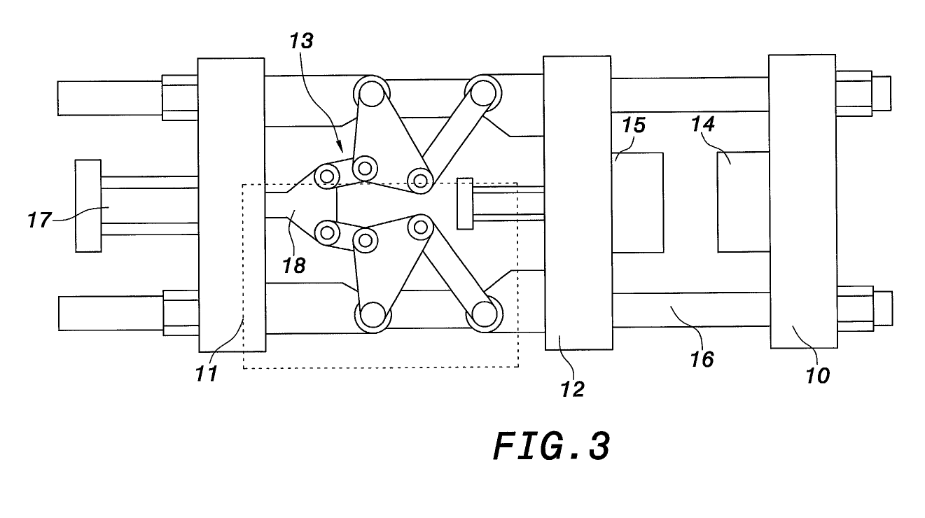

Referring to FIG. 2, the present invention provides a servo drive type automatic mold-adjusting control method applicable to a mold-clamping unit of the oil press type injection molding machine shown in FIG. 3. The oil press type injection molding machine comprises a static moldboard 10, a mold-adjusting board 11, a mobile moldboard 12 disposed between the static moldboard 10 and the mold-adjusting board 11, and a mold-clamping unit 13 for driving the mobile moldboard 12 to move. A first mold 14 is fixed on the static moldboard 10. The mobile moldboard 12 are slidably matched with tie bars 16 near four corners thereof. The mold-adjusting board 11 and the mobile moldboard 12 can be driven by a first driving device (not shown) like a mold-adjusting motor. The mold-clamping unit 13 is a toggle mechanism capable of being driven by a second driving device 17 (like a servo motor) via a screw rod and a cross head 18. The mold-clamping unit 13 can properly drive the mobile moldboard 12 to move through the guidance of the tie bars 16 so as to lead a second mold 15 on the mobile moldboard 12 to move, thereby letting the first mold 14 and the second mold 15 be capable of making open and close actions.

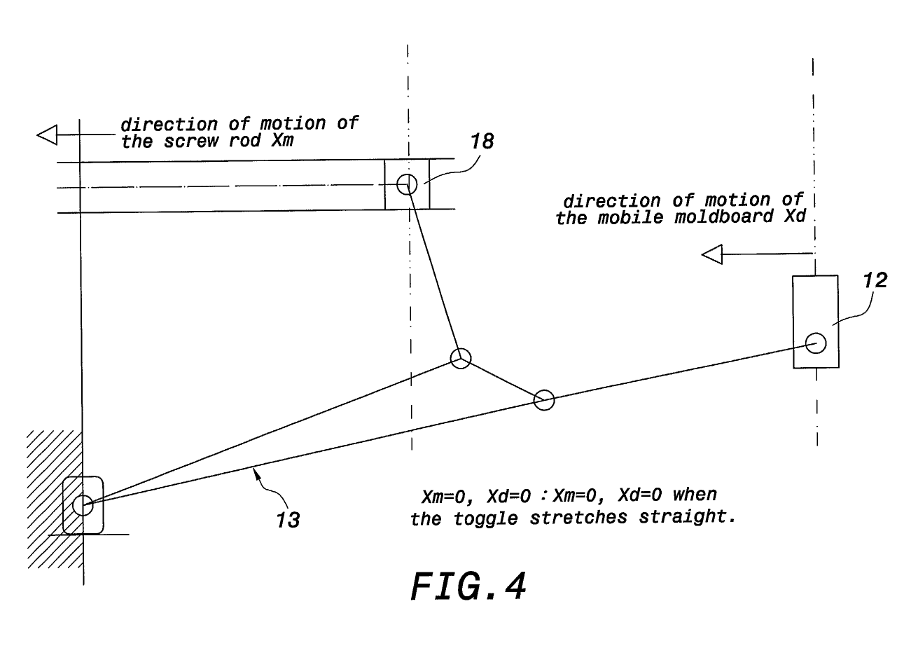

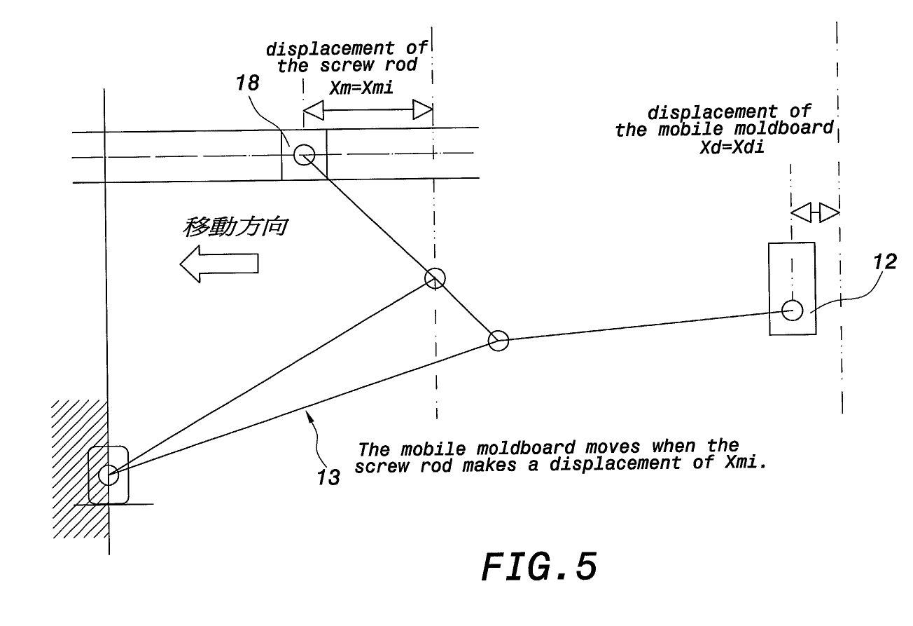

As shown in FIG. 2, the servo drive type automatic mold-adjusting control method of the present invention is an automatic adjustment method of the clamping unit. The present invention comprises the steps of (also referring to FIGS. 4 and 5):

(1) a user inputting the mold-locking force;

(2) receding the first driving device (e.g., the mold-adjusting motor) to the rear end;

(3) driving the second driving device (e.g., the servo motor) to stretch straight a toggle to let the mobile moldboard exactly contact the static moldboard;

(4) stopping the second driving device (Xd=Xm=0 at this time);

(5) driving the second driving device to recede the toggle some distance;

(6) stopping the second driving device;

(7) driving the first driving device to move forwards and letting the mold-adjusting board and the mobile moldboard face forwards so that the mobile moldboard and the static moldboard are close together; and

(8) stopping the first driving device to finish automatic mold adjustment.

In the present invention, when the toggle stretches straight, if the mobile moldboard exactly contacts the static moldboard, the mold-clamping force is near zero (because the tie bar has no extension). Assume the toggle recedes a distance of Xmi (i.e., the mobile moldboard moves a distance of Xdi toward the direction of molding) and the mold-adjusting board move forwards a distance of Xdi and is then fixed, if the toggle stretches straight at this time, the mobile moldboard cannot move forwards continually because it already contacts the static moldboard. Therefore, advance of the motor will result in deformation of the tie bars, hence building the mold-locking force.

The present invention makes use of turning on and off a servo motor and a mold-adjusting motor to perform automatic mold-adjusting control. Different from oil press, the present invention provides a more accurate, faster, and more sensitive automatic mold-adjusting control method, which can be used to resolve problems of a conventional oil press type injection molding machine due to bad automatic mold-adjusting control, thereby enhancing precision and performance of machine to achieve the object of accurate shaping.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A servo drive type automatic mold-adjusting control method comprising the steps of:
(1) a user inputting the mold-locking force;
(2) receding a first driving device to the rear end;
(3) driving a second driving device to stretch straight a toggle to let a mobile moldboard exactly contact a static moldboard;
(4) driving said second driving device to recede the toggle some distance;
(5) driving said first driving device to move forwards and letting a mold-adjusting board and the mobile moldboard face forwards so that the mobile moldboard and the static moldboard are close together; and
(6) stopping said first driving device to finish automatic mold adjustment.

2. The servo drive type automatic mold-adjusting control method as claimed in claim 1, wherein said first driving device is a mold-adjusting motor.

3. The servo drive type automatic mold-adjusting control method as claimed in claim 1, wherein said second driving device is a servo motor.
